(19) United States
(12) Patent Application Publication
(10) Pub. No.: US 2025/0189344 A1
(43) Pub. Date: Jun. 12, 2025

(54) APPARATUS AND METHOD FOR INTEGRATING MAP OF VEHICLE

(71) Applicants: HYUNDAI MOTOR COMPANY, Seoul (KR); Kia Corporation, Seoul (KR)

(72) Inventors: La Woo KIM, Hwaseong-si (KR); Han Shik KIM, Hwaseong-si (KR)

(73) Assignees: HYUNDAI MOTOR COMPANY, Seoul (KR); Kia Corporation, Seoul (KR)

(21) Appl. No.: 18/821,517

(22) Filed: Aug. 30, 2024

(30) Foreign Application Priority Data
Dec. 12, 2023 (KR) 10-2023-0180174

(51) Int. Cl. G01C 21/00; G01C 21/36

(52) U.S. Cl. CPC G01C 21/3878; G01C 21/3638; G01C 21/365; G01C 21/3658; G01C 21/3815; G01C 21/3881

(57) ABSTRACT

An apparatus for integrating a map of a vehicle includes a processor to classify a high definition map, which is previously stored, into a plurality of layers, to change the high definition map to include a format to be integrated with a standard definition map, and generate an integrated map obtained by integrating the standard definition map with the high definition map and a memory to store the integrated map.

### CROSS-REFERENCE TO RELATED APPLICATION

The present application claims priority to Korean Patent Application No. 10-2023-0180174, filed on Dec. 12, 2023, the entire contents of which is incorporated herein for all purposes by this reference.

### BACKGROUND OF THE PRESENT DISCLOSURE

### Field of the Present Disclosure

The present disclosure relates to an apparatus and a method for integrating a map of a vehicle, and more particularly, relates to an apparatus and a method for integrating a map of a vehicle, capable of integrating a standard definition map (SD map) with a high definition map to provide a precise service for directions.

### Description of Related Art

Navigation provides various options for searching for a route, such as the shortest distance to the destination and the minimum time, using a standard definition map (SD Map) stored in a vehicle, and provides the optimal route guidance information by allowing a driver to select the SD map.

In addition to providing road guidance information through the navigation, an Advanced Driver Assistance System (ADAS) function is provided to assist the driver in driving for the convenience of the driver, and a vehicle may recognize and judge the surrounding environment while driving using the ADAS map to minimize the handling of the driver and to operate the ADAS function safely.

Recently, as an autonomous driving technology is developed, the vehicle may autonomously determine a surrounding environment to perform lane change or obstacle avoidance. To the present end, a high definition map for providing more precisely information than the ADAS maps is used.

In general, the vehicle stores a navigation map, an ADAS map, or a precise map, and each map is utilized by an individual controller to generate information, which makes a limitation in increasing a storage capacity for storing the maps, and slowing down the processing speed of the controller.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus and a method for integrating a map of a vehicle, configured for integrating a standard definition map for an autonomous driving vehicle with a high definition map, and storing the integration result to optimize a map capacity, to facility the management of a map, and to extend a service provided for a navigation.

Another aspect of the present disclosure provides an apparatus and a method for integrating maps of a vehicle, configured for classifying a high definition map, which is previously stored, into a plurality of layers, and changing the high definition map to include a format to be integrated with a standard definition map, generating a map formed by integrating the standard definition map with the high definition map.

Another aspect of the present disclosure provides an apparatus and a method for integrating a map of a vehicle, configured for generating information for searching for a route to a destination, when the destination is input, and generating information for searching for the route, which includes a driving lane for the driving of the vehicle to arrive at the destination, providing precise information for directions.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for integrating a map of a vehicle, may include a processor to classify a high definition map, which is previously stored, into a plurality of layers, to change the high definition map to include a format to be integrated with a standard definition map, and generate an integrated map obtained by integrating the standard definition map with the high definition map, and a memory to store the integrated map.

According to an exemplary embodiment of the present disclosure, the processor may set, as a map tile, one of a plurality of divided portions obtained by dividing an image, which is output through an output device operatively connected to the processor, by a predetermined number, and classify information included in the one map tile into a plurality of layers.

According to an exemplary embodiment of the present disclosure, the processor may classify the information included in the one map tile into the plurality of layers including a lane layer, a standard definition (SD) match layer, a localization layer, a local match layer, and a route layer.

According to an exemplary embodiment of the present disclosure, the processor is configured to perform the classifying so that the lane layer includes a road link, a road node, a lane side, a lane link, and a boarder road link which are included in the one map tile.

According to an exemplary embodiment of the present disclosure, the processor is configured to perform the classifying so that the SD match layer includes a core matching table and a core node matching table.

According to an exemplary embodiment of the present disclosure, the processor may allow the core matching table to include a road link matched in the standard definition map and the high definition map, and an identification (ID) of the map tile including the road link.

According to an exemplary embodiment of the present disclosure, the processor may allow the core matching table to include information related to a node matched in the standard definition map and the high definition map, and an identification (ID) of the map tile including the node.

According to an exemplary embodiment of the present disclosure, the processor is configured to perform the classifying so that the localization layer includes information related to a road sign, a road mark, a road edge portion, a traffic light, a traffic sign, a road facility, and a pole.

According to an exemplary embodiment of the present disclosure, the processor may allow the local match layer to include a lane local matching table.

According to an exemplary embodiment of the present disclosure, the processor is configured to perform the classifying so that the lane local matching table includes information matched between the lane layer and the localization layer.

According to an exemplary embodiment of the present disclosure, the processor is configured to perform the classifying so that the route layer includes information related to a link, a node, a border link, and safety.

According to an exemplary embodiment of the present disclosure, the apparatus may further include an output device to output the integrated map.

According to an exemplary embodiment of the present disclosure, the processor may output, through the output device, information related to a host vehicle, a surrounding vehicle, and a driving lane, when an autonomous driving mode is activated.

According to an exemplary embodiment of the present disclosure, the processor is configured to generate information for searching for a route to a destination, based on the integrated map, when the destination is input.

According to an exemplary embodiment of the present disclosure, the processor is configured to generate the information for searching for the route by including a driving lane for driving of the vehicle to arrive at the destination.

According to an exemplary embodiment of the present disclosure, the processor may output, through the output device, the information for searching for the route, based on the integrated map, when the information for searching for the route is generated.

According to an exemplary embodiment of the present disclosure, the processor may output, through the output device, an image for guiding lane change based on a traffic amount of the driving lane, when the information for searching for the route is output.

According to an exemplary embodiment of the present disclosure, the processor may output, through the output device, an image for guiding a lane allowing driving, when the information for searching for the route is output.

According to an exemplary embodiment of the present disclosure, the output device may include an augmented reality head-up display.

According to another aspect of the present disclosure, a method for integrating a map of a vehicle, may include classifying, a high definition map, which is previously stored, into a plurality of layer to be changed to include a format stored in a memory including a standard definition map, generating an integrated map obtained by integrating the standard definition map with the high definition map.

According to an exemplary embodiment of the present disclosure, the method may further include storing the integrated map in the memory.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating the configuration of an apparatus for integrating a map of a vehicle, according to an exemplary embodiment of the present disclosure;

FIG. 2 is a schematically illustrating a standard definition map which is previously stored, according to an exemplary embodiment of the present disclosure;

FIG. 3 is a schematically illustrating a high definition map which is previously stored, according to an exemplary embodiment of the present disclosure;

FIG. 4 is a view schematically illustrating a plurality of layers obtained from a classification operation, according to an exemplary embodiment of the present disclosure;

FIG. 5 is a view schematically illustrating information used when generating information for searching for a route, according to an exemplary embodiment of the present disclosure;

FIG. 6, FIG. 7, and FIG. 8 are views exemplarily illustrating an image output according to an exemplary embodiment of the present disclosure;

FIG. 9 is a view exemplarily illustrating the operation of an apparatus for integrating a map of a vehicle, according to an exemplary embodiment of the present disclosure;

FIG. 10 is a view exemplarily illustrating a method for integrating a map of a vehicle, according to an exemplary embodiment of the present disclosure; and

FIG. 11 is a view exemplarily illustrating the configuration of a determining system to execute a method according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to accompanying drawings. In adding the reference numerals to the components of each drawing, it should be noted that the identical or equivalent component is designated by the identical numeral even when they are displayed on other drawings. Furthermore, in the following description of an exemplary embodiment of the present disclosure, a detailed description of well-known features or functions will be ruled out in order not to unnecessarily obscure the gist of the present disclosure.

In describing the components of the exemplary embodiment of the present disclosure, terms such as first, second, “A”, “B”, “(a)”, “(b)”, and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

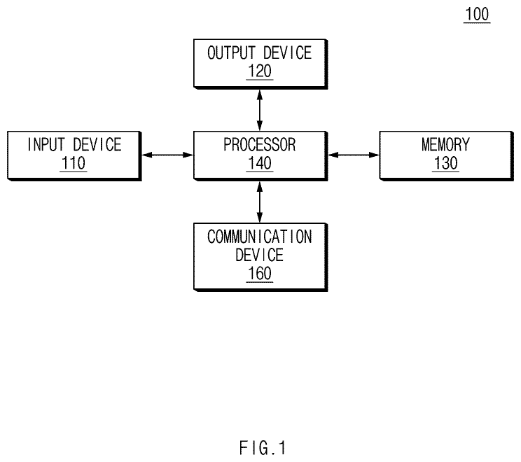

FIG. 1 is a view exemplarily illustrating the configuration of an apparatus for integrating a map of a vehicle, according to an exemplary embodiment of the present disclosure.

As illustrated in FIG. 1, the apparatus 100 for integrating the map of the vehicle may include a communication device 160, an input device 110, an output device 120, a memory 130, and a processor 140. According to an exemplary embodiment of the present disclosure, the apparatus 100 for integrating the map of the vehicle may be mounted in a navigation of the vehicle.

The input device 110 may receive an input corresponding to a touch, a motion, or a voice of a user and transmit the input to the processor 140. The processor 140 may be configured for controlling the operation of the apparatus for integrating the map of the vehicle to correspond to the input information. According to an exemplary embodiment of the present disclosure, the input device 110 may include a touch-type input device or a mechanical input device. According to an exemplary embodiment of the present disclosure, the input device 110 may be implemented with at least one of a motion sensor, a voice recognizing sensor to detect a motion or a voice of a user, or any combination thereof.

The output device 120 may output an image or a sound under the control of the processor 140. The output device 120 may output an integrated map, under the control of the processor 140. According to an exemplary embodiment of the present disclosure, the output device 120 may be implemented in a form of a display device or a sound output device (speaker). In the instant case, the display device may include an augmented reality head-up display, or a cluster. According to an exemplary embodiment of the present disclosure, the display device may be implemented in a form of a display device employing a liquid crystal display (LCD) panel, a light emitting diode (LED) panel, an organic light emitting diode (OLED) panel, or a plasma display panel (PDP). The liquid crystal display may include a thin film transistor liquid crystal display (TFT-LCD). The display device may be implemented integrally with a touch screen panel (TSP).

The memory 130 may store the integrated map obtained by integrating the high definition map, which includes a format changed to be integrated with a standard definition map, with the standard definition map. The memory 130 may store at least one algorithm to compute or execute various instructions for the operation of the apparatus for integrating the map of the vehicle, according to an exemplary embodiment of the present disclosure. According to an exemplary embodiment of the present disclosure, the memory 130 may store at least one instruction executed by the processor 140, and the instruction may allow the apparatus for integrating a map of the vehicle, to operate according to an exemplary embodiment of the present disclosure. The memory 130 may include at least one storage medium of at least one a flash memory, a hard disc, a memory card, a Read Only Memory (ROM), a Random Access Memory (RAM), an Electrically Erasable and Programmable ROM (EEPROM), a Programmable ROM (PROM), a magnetic memory, a magnetic disc, or an optical disc.

The processor 140 may be implemented by various processing devices, such as a microprocessor embedded therein with a semiconductor chip to operate or execute various instructions, and may be configured for controlling the apparatus for integrating a map of the vehicle according to an exemplary embodiment of the present disclosure.

The processor 140 may be electrically connected to the input device 110, the output device 120, the memory 130 and the communication device 160 through a wired cable or various circuits to transmit an electrical signal including a control command to execute an arithmetic operation or data processing related to a control operation and/or communication. The processor 140 may include at least one of a central processing unit, an application processor, a communication processor (CP), or the combination thereof.

In various exemplary embodiments of the present disclosure, the memory 130 and the processor 140 may be provided as one chip, or provided as separate chips.

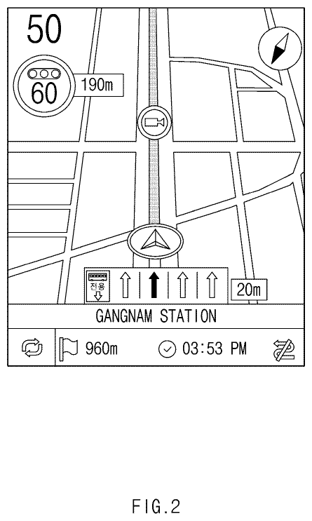

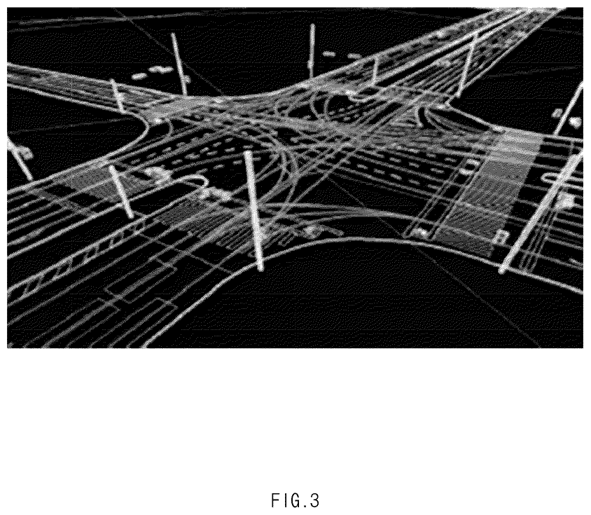

The processor 140 may classify the high definition map, which is previously stored in the memory, into a plurality of layers to be changed to include a format to be integrated with the standard definition map, generating the integrated map formed by integrating the standard definition map with the high definition map and storing the integrated map into the memory. In the instant case, the standard definition map and the high definition map will be described with reference to FIG. 2 and FIG. 3.

FIG. 2 is a view schematically illustrating the standard definition map, which is previously stored, according to an exemplary embodiment of the present disclosure, and FIG. 3 is a view schematically illustrating the high definition map which is previously stored, according to an exemplary embodiment of the present disclosure.

As illustrated in FIG. 2, the standard definition map refers to a map used for road-level route search and for guidance to a destination through a navigation. The standard definition map has the precision of about 3.5 m, and may provide a road, surrounding information, search, and safe driving information (speed limit).

As illustrated in FIG. 3, the high definition map refers to a map to which ADAS function and lane-level attribute information for autonomous driving are added. The precision of the high definition map may be about 0.2 m, and may provide the central line of a lane, the boundary line of the lane, or information related to the marking of a road surface.

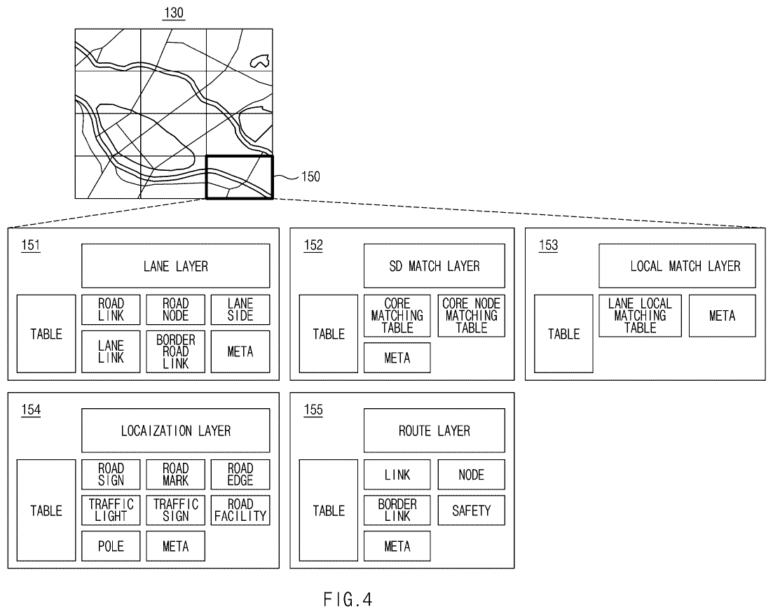

Referring back to FIG. 1, the processor 140 may set, as a map tile, one of a plurality of divided portions obtained by dividing an image, which is output through an output device operatively connected to the processor, by a predetermined number, and classify information included in the one map tile into a plurality of layers. The details thereof will be made with reference to FIG. 4.

FIG. 4 is a view schematically illustrating a plurality of layers obtained from the classification operation, according to an exemplary embodiment of the present disclosure.

As illustrated in FIG. 4, the processor 140 may set, as a map tile 150, one of a plurality of divided portions obtained by dividing an image (the high definition map), which is output through an output device operatively connected to the processor, by a predetermined number.

According to an exemplary embodiment of the present disclosure, the processor 140 may classify the image based on relevant information of information included in one map tile 150. According to an exemplary embodiment of the present disclosure, the processor 140 may classify the information included in the one map tile 150 into the plurality of layers including a lane layer 151, a standard definition match layer 152, a local match layer 153, a localization layer 154, and a route layer 155.

The processor 140 may perform the classification operation so that the lane layer 151 includes a road link, a road node, a lane side, a lane link, a boarder road link which are included in the one map tile. In the instant case, the road link may refer to the central line of the road, and the lane link may refer to the central line of the lane.

The processor 140 is configured to perform the classification operation so that the SD match layer 152 includes a core matching table and a core node matching table. According to an exemplary embodiment of the present disclosure, the processor 140 may be configured to allow the core matching table to include a road link matched in the standard definition map and the high definition map, and identification (ID) of the map tile including the matched road link. According to an exemplary embodiment of the present disclosure, the processor 140 may be configured to allow the core node matching table to include information related to a node matched in the standard definition map and the high definition map, and identification (ID) of the map tile including the node matched.

The processor 140 is configured to perform the classification operation so that the localization layer 154 includes information related to a road sign, a road mark, a road edge portion, a traffic light, a traffic sign, a road facility, and a pole. In the instant case, the information related to the marking of the road surface may include information related to a directional arrow on the road surface, and information (road edge portion) about an object of the road boundary may include a guardrail, a median strip, or a wall. The traffic light information may include the type of traffic light, and the arrangement type (horizontal type, vertical type) of the traffic light, and the number of lamps (2 colors, 3 colors, 4 colors) of the traffic light, and information related to the sign may include the size, the type, and the color of the sign indicating a precaution, a regulation, and an instruction necessary for traffic. The information related to the road facility may include a bridge, a toll gate, or a tunnel, and the information related to the pole may include a type (a street light, a security light, or a traffic light) of a pole, and information related to the pole.

The processor 140 may perform the classification operation to allow the local match layer 153 to include a lane local matching table. The processor 140 may be configured to allow the lane local matching table to include information matched in the lane layer 151 and the localization layer 154.

The processor 140 may be configured to perform the classification operation so that the route layer 155 includes information related to a link, a node, a border link, and safety. In the instant case, the link refers to a line connecting the node and the node. For example, the link includes a road, a bridge, an overpass, an underground road, or a tunnel and may include a link ID, IDs of a starting point and an ending point of the link, the link length, information related to a toll road, or information related to a speed. The node may include a point at which a vehicle speed is changed. For example, the node may include an intersection, a start point and an end point of a bridge, a start point and an end point of an overpass, a start point and an end point of the road, a start point and an end point of an underground road, a start point and an end point of a tunnel, an administrative boundary, and an IC/JC. Furthermore, the node may include a node ID, a connected link ID, and a link angle. The boundary link may include information related to a link passing through a map tile or connected to two map tiles, and the information related to the safety may include a speed bump, a speed camera, or an enforcement unit of safe operation.

According to an exemplary embodiment of the present disclosure, when information included in one map tile is classified into the plurality of layers, the processor 140 may allow each layer to include metadata and a table including the metadata to efficiently manage each layer.

Referring back to FIG. 1, when the information included in the map tile is classified into the plurality of layers, the processor 140 may be configured to generate the integrated map obtained by integrating the standard definition map with the high definition map. The processor 140 may be configured to generate the integrated map and store the integrated map in the memory 130, optimizing the capacity required for storing the map through format unification, facilitating the managing of the map, and unifying the version of the map. Accordingly, an additional controller to control the high definition map is not required to improve the processing speed.

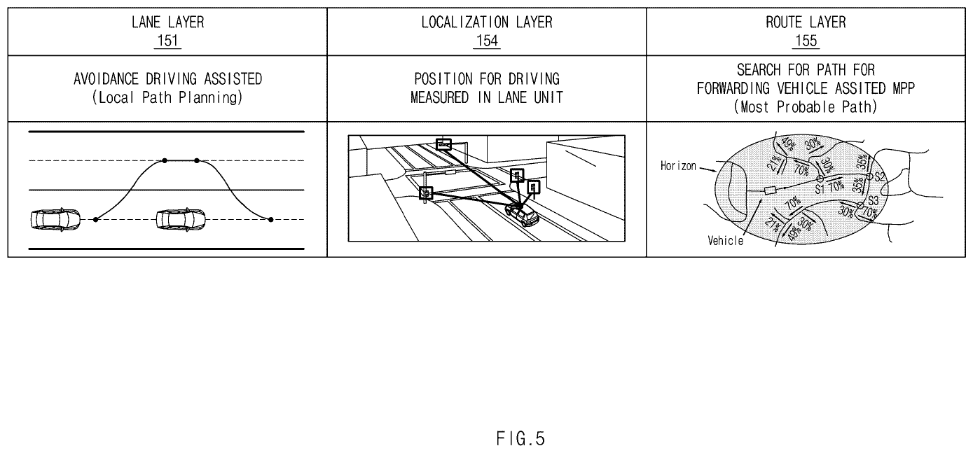

The processor 140 may be configured to generate information for searching for a route to a destination from a present location, based on the integrated map, when the destination is input through the input device 110. According to an exemplary embodiment of the present disclosure, the processor 140 may obtain the information related to the location of the vehicle through a global navigation satellite system (GNSS), and map-match the location of the vehicle to the integrated map to provide an image of a map of a certain area from the location of the vehicle. According to an exemplary embodiment of the present disclosure, the processor 140 may be configured to generate information for searching for the route including the driving lane for the driving of the vehicle to arrive at the destination. The processor 140 may use a plurality of classified layers when generating the information for searching for the route to the destination. The details thereof will be described with reference to FIG. 5.

FIG. 5 is a view schematically illustrating information used when generating information for searching for a route, according to an exemplary embodiment of the present disclosure.

As illustrated in FIG. 5, the processor 140 may assist avoidance driving based on a lane using the lane layer 151 and may be configured to generate the information related to the searching for a route for avoiding an accident vehicle (stopped vehicle) when the information related to the searching for the route to the destination is generated and the accident vehicle (stopped vehicle) is present in front.

The processor 140 may measure the location for the driving of a lane unit using the localization layer 154, may obtain information related to a traffic light around a road on which the vehicle is driving, and may be configured to generate the information related to the searching for the route to the destination, based on the information related to the traffic light.

The processor 140 may search for a route for the forwarding of the vehicle by use of the route layer 155, and may be configured to generate the information related to the searching for the route to the destination, based on the result of the searching for the route for the forwarding of the vehicle.

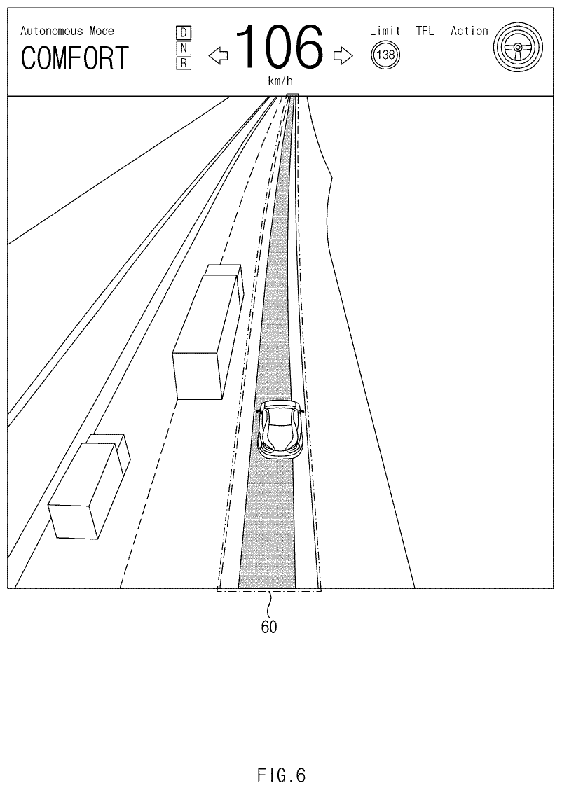

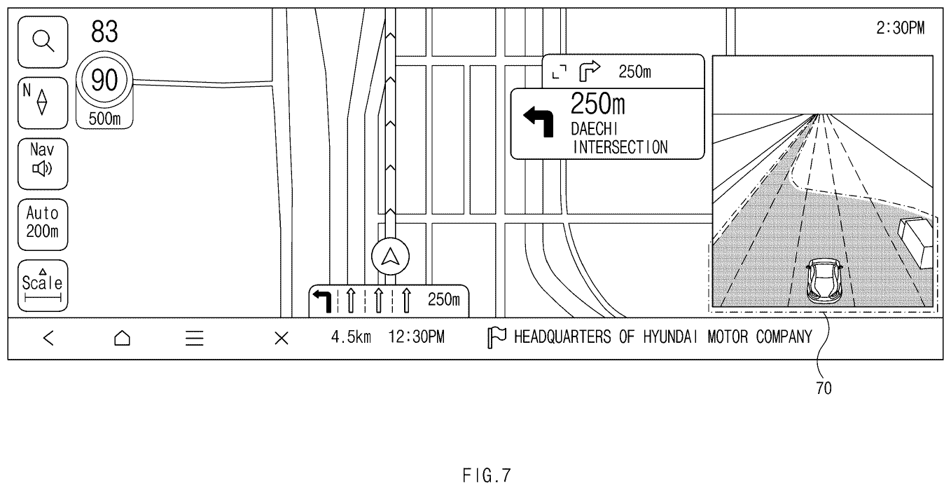

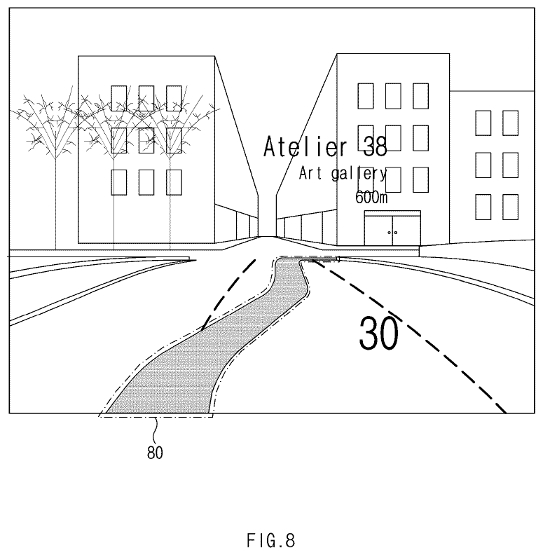

Referring back to FIG. 1, when the integrated map is generated, the processor 140 may output the integrated map through the output device 120. When the information related to the searching for the route to the destination is generated, the information related to the searching for the route to the destination may output through the output device 120, based on the integrated map. The details thereof will be described with reference to FIGS. 6 to 8.

FIG. 6, FIG. 7, and FIG. 8 are views exemplarily illustrating an image output according to an exemplary embodiment of the present disclosure.

As illustrated in FIG. 6, according to an exemplary embodiment of the present disclosure, the processor 140 may output information related to the host vehicle, the surrounding vehicle, and the information (e.g., a present speed or a speed limit) about the driving lane, based on the integrated map, through the output device 120, when an autonomous driving mode is activated. Furthermore, when the information related to the searching for the route is generated, the processor 140 may output a driving lane for the driving of the vehicle to arrive at the destination. According to an exemplary embodiment of the present disclosure, the processor 140 may output the driving lane for the driving of the vehicle to arrive at the destination by overlaying the driving lane for the driving of the vehicle to arrive at the destination with a line-type image 60.

As illustrated in FIG. 7, according to an exemplary embodiment of the present disclosure, the processor 140 may output, through the output device 120, an image 70 for guiding a lane allowing driving together, when outputting the information related to the searching for the route. According to an exemplary embodiment of the present disclosure, the processor 140 may output the image for guiding the lane allowing the driving through a pop-up screen or a voice. According to an exemplary embodiment of the present disclosure, the processor 140 may output the lane allowing the driving in color different from the color of a lane prohibiting the driving so that the lane allowing driving is recognized.

As illustrated in FIG. 8, according to an exemplary embodiment of the present disclosure, the processor 140 may output an image 80 for guiding lane change based on a traffic amount of the driving lane, when outputting the information related to the searching for the route. Furthermore, the processor 140 may output an image for guiding the lane change in advance to turn left or turn light. According to an exemplary embodiment of the present disclosure, the processor 140 may output the image for guiding the lane change, as an augmented reality image including a route which links to a target lane for the lane change from the driving lane on which the vehicle is driving. According to an exemplary embodiment of the present disclosure, the processor 140 may output an image for guiding the lane change, which is overlaid with the image in the type of a line linking from the driving lane to the target lane for the lane change.

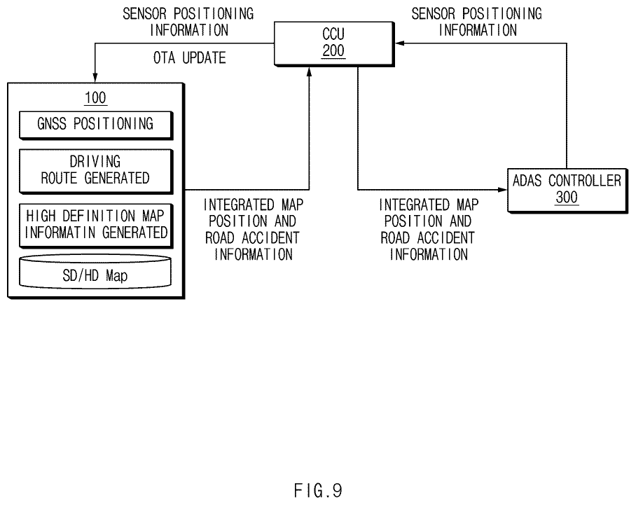

Referring back to FIG. 1, the processor 140 may provide an integrated map to an ADAS controller 300 which is configured to control an Advanced Driver Assistance System (ADAS) function that assists the driving of a driver, allowing the ADAS function to operate based on the integrated map. The details thereof will be described with reference to FIG. 9.

FIG. 9 is a view exemplarily illustrating the operation of an apparatus for integrating a map of a vehicle, according to an exemplary embodiment of the present disclosure.

As illustrated in FIG. 9, when the integrated map is generated, the processor 140 may transmit the integrated map to a communication control device (CCU) 200 via the communication device 160 of the apparatus 100.

The communication control device 200 may communicate with a vehicle interior device, and may perform wireless communication (Vehicle-to-Vehicle (V2V), or Vehicle-to-Everything (V2X)) with a vehicle external device (another vehicle, server). According to an exemplary embodiment of the present disclosure, the communication control device 200 may communicate with the ADAS controller 300 to transmit the integrated map, the information related to the location of the vehicle, and information related to a road accident (accident information, road control information) to the ADAS controller 300. The ADAS controller 300 may control driving (autonomous driving) of the vehicle using information obtained from sensors of the vehicle. The information obtained from sensors include information that sensors of the vehicle detect surrounding environment of the vehicle and position of the vehicle.

The communication control device 200 may receive information obtained from sensors, from the ADAS controller 300, and the processor 140 may receive information obtained from sensors, from the communication control device 200. The processor 140 may update the apparatus 100 for integrating the map of the vehicle on over the air (OTA) through the communication control device 200, by wireless.

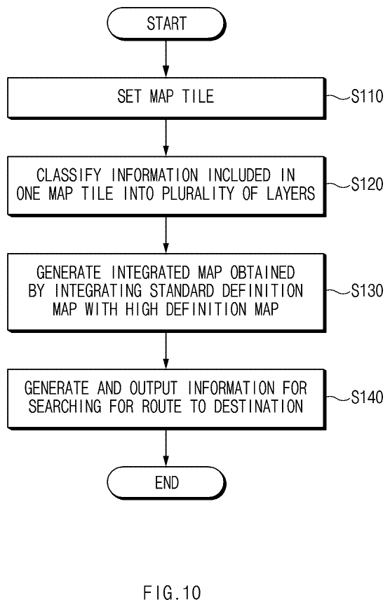

FIG. 10 is a view exemplarily illustrating a method for integrating a map of a vehicle, according to an exemplary embodiment of the present disclosure.

As illustrated in FIG. 10, the processor 140 may set, as a map tile 150, one of a plurality of divided portions obtained by dividing an image (the high definition map), which is output through an output device operatively connected to the processor, by a predetermined number (S110).

According to an exemplary embodiment of the present disclosure, the processor 140 may perform a dividing and classifying operation based on relevant information of information included in one map tile 150 (S120).

In S120, according to an exemplary embodiment of the present disclosure, the processor 140 may classify the information included in the one map tile 150 into the plurality of layers including the lane layer 151, the standard definition match layer 152, the local match layer 153, the localization layer 154, and the route layer 155.

Referring back to FIG. 1, when the information included in the map tile is classified into the plurality of layers, the processor 140 may be configured to generate the integrated map obtained by integrating the standard definition map with the high definition map (S130). The processor 140 may be configured to generate the integrated map and store the integrated map in the memory 130, optimizing the capacity required for storing the map through format unification, facilitating the managing of the map, and unifying the version of the map.

The processor 140 may be configured to generate and output information for searching for a route to a destination from a present position of the vehicle, based on the integrated map, when the destination is input through the input device 110 (S140). In S140, according to an exemplary embodiment of the present disclosure, the processor 140 may obtain the information related to the vehicle through a global navigation satellite system (GNSS), and map-match the location of the vehicle to the integrated map to provide an image of a map of a certain area from the location of the vehicle. According to an exemplary embodiment of the present disclosure, the processor 140 may be configured to generate information for searching for the route including the driving lane for the driving of the vehicle to arrive at the destination. When the information for searching for the route to the destination is generated, the processor 140 may output, through the output device 120, the information for searching for the route to the destination based on the integrated map.

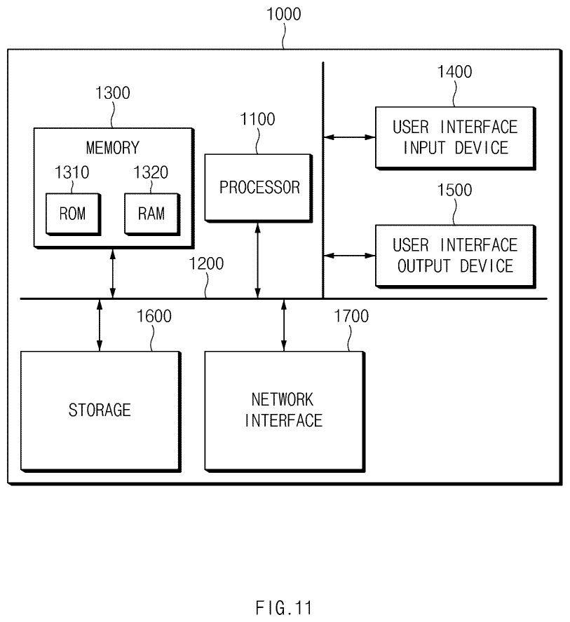

FIG. 11 is a view exemplarily illustrating the configuration of a computing system to execute a method according to an exemplary embodiment of the present disclosure.

Referring to FIG. 11, a computing system 1000 may include at least one processor 1100, a memory 1300, a user interface input device 1400, a user interface output device 1500, a storage 1600, and a network interface 1700, which are connected to each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only ROM 1310 and a RAM 1320.

Thus, the operations of the method or algorithm described in connection with the exemplary embodiments included in the present disclosure may be directly implemented with a hardware module, a software module, or the combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

According to an exemplary embodiment of the present disclosure, in the apparatus and the method for integrating the map of the vehicle, the standard definition map for the autonomous driving vehicle may be integrated with the high definition map, and stored to optimize the map capacity, to facility the management of the map, and to extend the service provided for the navigation.

According to an exemplary embodiment of the present disclosure, in the apparatus and the method for integrating the map of the vehicle, the high definition map, which is previously stored, may be classified into the plurality of layers, and the high definition map may be changed to include the format to be integrated with the standard definition map, generating the map formed by integrating the standard definition map with the high definition map.

According to an exemplary embodiment of the present disclosure, in the apparatus and the method for integrating the map of the vehicle, the information for searching for the route to the destination may be generated when the destination is input, and the information for searching for the route, which includes the driving lane for the driving of the vehicle to arrive at the destination, may be generated, providing precise information for directions.

The above description is merely an example of the technical idea of the present disclosure, and various modifications and modifications may be made by one skilled in the art without departing from the essential characteristic of the present disclosure.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed based on the accompanying claims, and all the technical ideas within the scope equivalent to the claims should be included in the scope of the present disclosure.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for integrating a map of a vehicle, the apparatus comprising:
a processor configured to classify a high definition map, which is previously stored, into a plurality of layers, to change the high definition map to include a format to be integrated with a standard definition map, and generate an integrated map obtained by integrating the standard definition map with the high definition map; and
a memory configured to store the integrated map.

2. The apparatus of claim 1, wherein the processor is further configured to:
set, as a map tile, one of a plurality of divided portions obtained by dividing an image, which is output through an output device operatively connected to the processor, by a predetermined number, and classify information included in the map tile into the plurality of layers.

3. The apparatus of claim 2, wherein the processor is further configured to:
classify the information included in the map tile into the plurality of layers including a lane layer, a standard definition (SD) match layer, a localization layer, a local match layer, and a route layer.

4. The apparatus of claim 3, wherein the processor is further configured to:
perform the classifying so that the lane layer includes a road link, a road node, a lane side, a lane link, and a boarder road link which are included in the map tile.

5. The apparatus of claim 3, wherein the processor is further configured to:
perform the classifying so that the SD match layer includes a core matching table and a core node matching table.

6. The apparatus of claim 5, wherein the processor is further configured to:
allow the core matching table to include a road link matched in the standard definition map and the high definition map, and an identification (ID) of the map tile including the road link.

7. The apparatus of claim 5, wherein the processor is further configured to:
allow the core matching table to include information related to a node matched in the standard definition map and the high definition map, and an identification (ID) of the map tile including the node.

8. The apparatus of claim 3, wherein the processor is further configured to:
perform the classifying so that the localization layer includes information related to a road sign, a road mark, a road edge portion, a traffic light, a traffic sign, a road facility, and a pole.

9. The apparatus of claim 3, wherein the processor is further configured to:
allow the local match layer to include a lane local matching table.

10. The apparatus of claim 9, wherein the processor is further configured to:
perform the classifying so that the lane local matching table includes information matched between the lane layer and the localization layer.

11. The apparatus of claim 3, wherein the processor is further configured to:
perform the classifying so that the route layer includes information related to a link, a node, a border link, and safety.

12. The apparatus of claim 1, further including:
an output device operatively connected to the processor and configured to output the integrated map.

13. The apparatus of claim 12, wherein the processor is further configured to:
output, through the output device, information related to a host vehicle, a surrounding vehicle, and a driving lane, in response that an autonomous driving mode is activated.

14. The apparatus of claim 12, wherein the processor is further configured to:
generate information for searching for a route to a destination, based on the integrated map, in response that the destination is input.

15. The apparatus of claim 14, wherein the processor is further configured to:
generate the information for searching for the route by including a driving lane for driving of the vehicle to arrive at the destination.

16. The apparatus of claim 15, wherein the processor is further configured to:
output, through the output device, the information for searching for the route, based on the integrated map, in response that the information for searching for the route is generated.

17. The apparatus of claim 15, wherein the processor is further configured to:
output, through the output device, an image for guiding lane change based on a traffic amount of the driving lane, in response that the information for searching for the route is output.

18. The apparatus of claim 14, wherein the processor is further configured to:
output, through the output device, an image for guiding a lane allowing driving, in response that the information for searching for the route is output.

19. The apparatus of claim 12, wherein the output device includes an augmented reality head-up display.

20. A method for integrating a map of a vehicle, the method comprising:
classifying, a high definition map, which is previously stored, into a plurality of layer to be changed to include a format stored in a memory including a standard definition map;
generating an integrated map obtained by integrating the standard definition map with the high definition map; and
storing the integrated map in the memory.
